(19) United States
(12) Patent Application Publication
(10) Pub. No.: US 2026/0170946 A1
(43) Pub. Date: Jun. 18, 2026

(54) APPARATUS AND METHOD FOR PROVIDING REAL-TIME TRAFFIC INFORMATION

(71) Applicants: HYUNDAI MOTOR COMPANY, Seoul (KR); KIA CORPORATION, Seoul (KR)

(72) Inventors: Namhyuk Kim, Hwaseong-si (KR); Sung Hwan Park, Hwaseong-si (KR); Youngwoo Park, Hwaseong-si (KR)

(73) Assignees: HYUNDAI MOTOR COMPANY, Seoul (KR); KIA CORPORATION, Seoul (KR)

(21) Appl. No.: 19/290,676

(22) Filed: Aug. 5, 2025

(30) Foreign Application Priority Data
Dec. 16, 2024 (KR) 10-2024-0186674

(51) Int. Cl. G08G 1/01; G06F 40/10; G06V 20/54; G08G 1/052

(52) U.S. Cl. CPC G08G 1/0133; G06F 40/10; G06V 20/54; G08G 1/0116; G08G 1/0145; G08G 1/052

(57) ABSTRACT

An apparatus for providing real-time traffic information includes a traffic information collection unit configured to collect, in real time while a user vehicle is travelling along a travel route, traffic information comprising a real-time travel speed and a cause of traffic congestion. The apparatus further includes a traffic congestion section determination unit configured to determine a normal speed range based on the traffic information and determine a section with a real-time travel speed lower than a lower limit of the normal speed range as a traffic congestion section. The apparatus further includes a traffic congestion section information providing unit configured to provide traffic congestion section information comprising at least one of a location of the traffic congestion section, the cause of the traffic congestion, or an expected delay time based on the traffic information and the traffic congestion section included in the travel route of the user vehicle.

### CROSS-REFERENCE TO RELATED APPLICATION

This present application claims the benefit of and priority to Korean Patent Application No. 10-2024-0186674, filed on Dec. 16, 2024, in the Korean Intellectual Property Office, the entire contents of which are incorporated herein by reference.

### TECHNICAL FIELD

The present disclosure relates to an apparatus and a method for providing real-time traffic information, and more specifically, the present disclosure relates to an apparatus and a method for providing real-time traffic information that provide, in real time, traffic information collected in real time.

### BACKGROUND

In general, traffic information can be classified as either traffic flow information or incident information.

Traffic flow information may include current traffic conditions, such as a vehicle speed for each road segment, vehicle density within the segments, and total travel time.

Drivers can check such traffic flow information through visual display features, such as route colors displayed on navigation systems and mobile applications.

Incident information may include information about traffic accidents, broken-down vehicles, roadworks, rallies, gatherings, and the like and may include emergency traffic information affecting the traffic flow.

Drivers can check such incident information through CCTV footage provided by traffic management systems, posts on traffic information center websites, traffic information social media, and traffic broadcasts.

Generally, traffic broadcasts are the typical method for receiving incident information and the like in real time.

However, traffic broadcasts provide information focused on major roads based on the day of the week and time of day, such as highways on weekends, congested areas during weekday rush hours, and work zones during daytime hours.

Existing methods for providing traffic information through navigation systems and mobile applications only display traffic flow information, making it difficult for drivers to determine what has caused the traffic congestion in a traffic congested section.

In addition, existing methods for providing traffic information primarily provide information on major roads, resulting in drivers being unable to receive incident information related to their travel route or being forced to listen to information about road sections unrelated to their travel route, leading to fatigue or time consumption.

The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure is directed to providing an apparatus and a method for providing real-time traffic information, collecting traffic information including a cause of traffic congestion in real time, and providing the traffic information in real time.

The present disclosure is further directed to providing an apparatus and a method for providing real-time traffic information, selecting, among traffic congestion section information, traffic congestion section information corresponding to a travel route of a user vehicle, and providing the traffic information in real time.

The present disclosure is further directed to providing an apparatus and a method for providing real-time traffic information and providing traffic congestion section information in real time by using a traffic information retrieval-augmented generation large language model.

Objects of the present disclosure are not limited to the above-mentioned object, and other objects and advantages of the present disclosure, which are not mentioned, should be understood through the following description and should become apparent from embodiments of the present disclosure. It should be also understood that the objects and advantages of the present disclosure may be realized by means and combinations thereof set forth in claims.

An apparatus for providing real-time traffic information according to one embodiment of the present disclosure includes a traffic information collection unit configured to collect, in real time while a user vehicle is travelling along a travel route, traffic information including a real-time travel speed and a cause of traffic congestion. The apparatus further includes a traffic congestion section determination unit configured to determine a normal speed range based on the traffic information and determine a section with a real-time travel speed lower than a lower limit of the normal speed range as a traffic congestion section. The apparatus further includes a traffic congestion section information providing unit configured to provide traffic congestion section information comprising at least one of a location of the traffic congestion section, the cause of the traffic congestion, or an expected delay time based on the traffic information and the traffic congestion section included in the travel route of the user vehicle.

The traffic information collection unit may analyze a real-time traffic image for each road section provided through an intelligent transport system by using an image analysis model. The traffic information may comprise at least one of real-time traffic accident information, rally information, event information, traffic control information, or roadwork information.

The traffic congestion section determination unit may determine the normal speed range according to a preset cycle by using a traffic pattern prediction model that uses the real-time travel speed as training data.

A method for providing real-time traffic information according to another embodiment of the present disclosure includes collecting, in real time while a user vehicle is travelling along a travel route, traffic information including a real-time travel speed and a cause of traffic congestion. The method further includes calculating a normal speed range based on the traffic information. The method further includes determining a section with a real-time travel speed lower than a lower limit of the normal speed range as a traffic congestion section. The method further includes providing traffic congestion section information comprising at least one of a location of the traffic congestion section, the cause of the traffic congestion, or an expected delay time based on the traffic information and the traffic congestion section included in the travel route of the user vehicle.

The collecting traffic information in real time may include analyzing a real-time traffic image for each road section provided by an intelligent transport system by using an image analysis model. The traffic information may include at least one of real-time traffic accident information, rally information, event information, traffic control information, or roadwork information.

The determining a section as a traffic congestion section may further include calculating the normal speed range according to a preset cycle by using a traffic pattern prediction model that uses the real-time travel speed as training data.

According to the present disclosure, by collecting traffic information including the cause of traffic congestion in real time, traffic congestion section information that includes the cause of the traffic congestion can be provided to a user in real time.

In addition, by selecting, among the traffic congestion section information, traffic congestion section information corresponding to a travel route of a user vehicle, traffic congestion section information selected based on the travel route of the user vehicle can be provided in real time.

In addition, by utilizing a retrieval-augmented generation large language model, traffic congestion section information can be provided in real time at reduced cost and time.

### BRIEF DESCRIPTION OF THE DRAWINGS

The foregoing and other aspects, features, and advantages, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a block diagram illustrating an apparatus for providing real-time traffic information according to one embodiment of the present disclosure.

FIG. 2 is a flowchart illustrating a method for providing real-time traffic information according to one embodiment of the present disclosure.

FIG. 3 is a diagram illustrating a method for providing real-time traffic information according to one embodiment of the present disclosure.

### DETAILED DESCRIPTION

The embodiments disclosed in the present disclosure are described in greater detail with reference to the accompanying drawings, and throughout the accompanying drawings, the same reference numerals are used to designate the same or similar components, and redundant descriptions thereof are omitted. As used herein, the terms “module” and “unit” used to refer to components are used interchangeably in consideration of convenience of explanation, and thus the terms per se should not be considered as having different meanings or functions. In relation to describing the present disclosure, when the detailed description of the relevant known technology is determined to unnecessarily obscure the gist of the present disclosure, the detailed description may be omitted. Furthermore, it should be understood that the appended drawings are intended only to help understand embodiments disclosed in the present disclosure and do not limit the technical principles and scope of the present disclosure. Rather, it should be understood that the appended drawings include all of the modifications, equivalents, or substitutes described by the technical principles and belonging to the technical scope of the present disclosure.

Although the terms first, second, third, and the like may be used herein to describe various elements, components, regions, layers, and/or sections, these elements, components, regions, layers, and/or sections should not be limited by these terms. These terms are only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present between the elements or the layers. In contrast, when an element is referred to as being “directly on,” “directly engaged to,” “directly connected to,” or “directly coupled to” another element or layer, there may be no intervening elements or layers present between the elements or the layers.

When a controller, unit, module, component, device, element, or the like of the present disclosure is described as having a purpose or performing an operation, function, or the like, the controller, unit, module, component, device, element, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

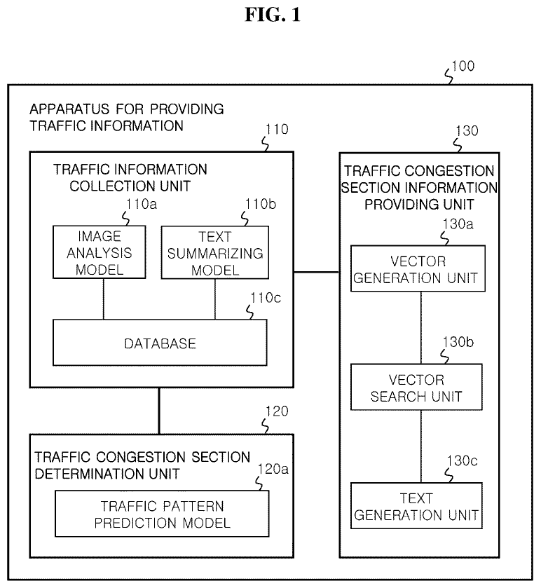

Hereinafter, an apparatus and a method for providing real-time traffic information according to the present disclosure are described in detail with reference to FIGS. 1-3.

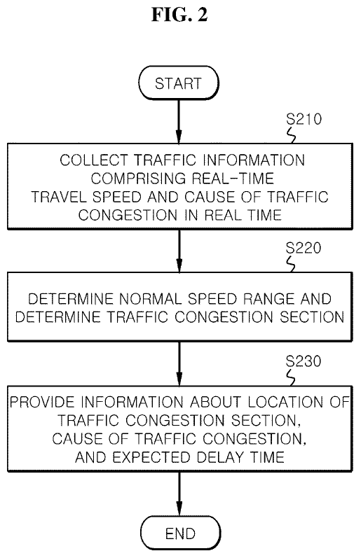

FIG. 1 is a block diagram illustrating an apparatus for providing real-time traffic information according to one embodiment of the present disclosure, and FIG. 2 is a flowchart illustrating a method for providing real-time traffic information according to one embodiment of the present disclosure.

Referring to FIG. 1, an apparatus for providing real-time traffic information 100 according to one embodiment of the present disclosure may comprise a traffic information collection unit 110, a traffic congestion section determination unit 120, and a traffic congestion section information providing unit 130.

The traffic information collection unit 110 collects, in real time, traffic information including a real-time travel speed and a cause of traffic congestion (see S210 in FIG. 2) while a user vehicle is travelling along a travel route.

For example, the traffic information collection unit 110 may collect information on a real-time travel speed, real-time traffic accidents, rallies, events, traffic control, roadworks, and the like for each road section provided through an intelligent transport system.

For example, the traffic information collection unit 110 may collect traffic information through the Seoul Transport Operation and Information Service, Road Plus, the Urban Traffic Information Center, the Traffic Broadcasting Network (TBN), and Twitter. In addition, the traffic information collection unit 110 may collect traffic accident information through closed circuit television (CCTV), the National Traffic Information Center, district police stations and police stations, and the like. The traffic information collection unit 110 may collect construction and roadwork information through local government documents, the National Police Agency, regular investigation results, and the like, may collect information on natural disasters such as forest fires, landslides, flooding, river flooding, rainfall, and heavy snow through CCTV, national disaster text messages, the National Police Agency, local government disaster text messages, and the like. The traffic information collection unit 110 may collect rally information through CCTV, the National Police Agency, and the like. The traffic information collection unit 110 may collect event information through the Korea Tourism Organization, portal press releases, local government notices, Marathon Online, and the like.

The traffic information collection unit may analyze real-time traffic images for each road section provided through the intelligent transport system using an image analysis model 110a and may collect, in real time, a cause of traffic congestion occurring in a relevant section. Here, the intelligent transport system (ITS) refers to a system that provides traffic information and services by combining electronics, control, and communication technologies.

The traffic information collection unit 110 may collect a large amount of traffic information using public APIs provided in formats, such as extensible markup language (XML) and JavaScript Object Notation (JSON). The traffic information collection unit 110 may extract traffic information from, for example, text-converted traffic broadcasts, text messages (SMS; short message service) comprising traffic information, and social network service (SNS) streams.

In addition, the traffic information collection unit 110 may use a text summarizing model 110b to classify the collected traffic information by road section. The traffic information collection unit 110 may generate summarized traffic information including the locations of congestion sections, the causes of traffic congestion, and expected delay times, etc. Here, the expected delay time may be calculated based on a normal speed range and a real-time travel speed, to be described below. For example, the expected delay time may be calculated as the difference between an upper limit of the normal speed range and the real-time travel speed.

Finally, the traffic information collection unit 110 may store the summarized traffic information in a database 110c. At this time, the data stored in the database 110c may be raw data before preprocessing has been performed.

For example, the traffic information collection unit 110 may collect data through an API request module, such as an HTTP client (e.g., the requests library in Python) or a WebSocket client (e.g., the socket.io-client library in Node.js), executed on a server equipped with a processor and storage. The traffic information collection unit 110 may perform API communication through a network interface (e.g., a standard Ethernet interface).

In another embodiment, the traffic information collection unit 110 may collect real-time travel speeds based on GPS, acceleration, and rotation information generated from individual vehicles. Accordingly, the traffic information collection unit 110 may publish real-time travel speeds vᵢ(t) by point i according to time t. Based on this, the traffic congestion section determination unit 120 may calculate normal speed data v_{avg_i}(t) by time period through a statistical model or an artificial intelligence regression model based on accumulated real-time travel speeds vᵢ(t). This may be calculated as an average value or as a range. Finally, the traffic congestion section determination unit may determine point-specific congestion situation data xᵢ(t) based on vᵢ(t) and v_{avg_i}(t). The traffic information collection unit may be implemented to subscribe to xᵢ(t) from the traffic congestion section determination unit and may, when xᵢ(t) is published, update the database through a scheduler. The traffic congestion section determination unit may determine xᵢ(t) as 1 (deemed a congestion situation compared to the normal speed) when vᵢ(t) is smaller than v_{avg_i}(t) by a preset threshold value, and otherwise the traffic congestion section determination unit may determine xᵢ(t) as 0.

In still another embodiment, when text collected by the traffic information collection unit comprises information about expected end periods of lane control due to traffic accidents, or scheduled congestion situations for a future point in time t_{f} that have not yet occurred, such as marathons and rallies, congestion situation data xᵢ(t_{f}) for the corresponding time points may be recorded.

Meanwhile, the traffic information collection unit 110 may be implemented to determine the number of vehicles included in each link and determine a road congestion index proportional to the number of vehicles per link, the frequency of adaptive cruise control operations, and the frequency of blind spot warning system operations. The traffic congestion section determination unit 120 may be implemented to determine congestion sections based on the congestion index.

Traffic information may be collected in the form of organized HTML tables or sentences such as “The [unavailable lanes] of [road name] from [congestion section start point] to [congestion section end point] is [control status] due to [congestion reason]. Please drive carefully.” At this time, the congestion time t included in the traffic information may be explicitly posted on a site or determined according to the time collected by the traffic information collection unit 110. Additionally, traffic information may be an HTML file from a preset website that is downloaded regularly. For example, the traffic information collection unit 110 may assign JSON identifier key values to collected texts in the order they are collected. When traffic congestion reasons for each point are posted on traffic information sites as tables or structured sentences, and information located structurally in the same position can be extracted using the same selector, it may be structured in JSON format. Texts separated by JSON key values may be used as metadata for vectors and utilized as filtering conditions during vector searches. For example, these filtering conditions may be implemented to filter by criteria such as within a few minutes before or after a specific time, within a few kilometers from a congestion location, or the like.

Meanwhile, when text about an occurring congestion section has not yet been posted, a plurality of images can be acquired by capturing real-time streaming CCTV footage for the corresponding section based on the location of the congestion section obtained through the traffic congestion section determination unit of the present disclosure. The traffic information collection unit may also be implemented to recognize the captured plurality of images and output text including the cause of congestion through a known machine learning model that describes road conditions.

The traffic congestion section determination unit 120 calculates a normal speed range for each road section based on the traffic information accumulated in the database and determines sections with real-time travel speeds lower than a lower limit of the normal speed range as traffic congestion sections (see S220 in FIG. 2).

For example, the traffic congestion section determination unit may output the normal speeds according to a preset cycle by using a traffic pattern prediction model 120a that generates a normal speed pattern for each road section using accumulated travel speed data (e.g., travel speeds by day of the week and time of day) stored in the database 110c as training data.

For example, the traffic pattern prediction model may use travel speed data categorized by preset cycles, such as by road, day of the week, and time of day, as training data, may generate prediction data for each preset cycle with patterns similar to the training data for travel speeds by road, day of the week, and time of day, and may calculate the normal speed range corresponding to the road, day, and time of day.

Meanwhile, when a cause of traffic congestion (e.g., a traffic accident) exists, the real-time travel speed may be lower than the lower limit of the normal speed range.

Accordingly, the traffic congestion section determination unit compares the normal speed for each road section with the real-time travel speed and determines a section where the real-time travel speed is lower than the lower limit of the normal speed range as a traffic congestion section.

For example, the traffic congestion section determination unit may output congestion sections using a speed pattern learning model and congestion section determination model executed on a server equipped with a processor and storage.

The traffic congestion section information providing unit 130 provides traffic congestion section information including at least one of a location of the traffic congestion section, a cause of the traffic congestion, or an expected delay time, based on the traffic information and the traffic congestion sections included in a travel route of the user vehicle (see S230 in FIG. 2).

For example, when a specific road section is determined to be a traffic congestion section and a cause of the congestion for the relevant road section is collected, the traffic congestion section information providing unit 130 may provide this information to the user vehicle until the traffic congestion for the relevant road section clears or the cause is updated.

Here, the cause of the traffic congestion may include, for example, an accident, a rally, an event, traffic control, and roadworks, and the expected delay time may be the time delayed compared to normal conditions due to the traffic congestion.

The traffic congestion section information providing unit comprises a vector generation unit 130a, a vector search unit 130b, and a text generation unit 130c.

The vector generation unit 130a may generate a traffic information vector by dividing and expanding the traffic information based on at least one of a preset token count unit, a sentence boundary, or a paragraph boundary, and performing vectorization.

Furthermore, the vector generation unit 130a may generate a route vector by dividing and expanding the traffic congestion section included in the travel route of the user vehicle based on at least one of a preset token count unit, a sentence boundary, or a paragraph boundary, and performing vectorization.

The generated traffic information vector and route vector may be stored in a vector database.

A vector search unit 130b retrieves, from the vector database, a traffic information vector that is close to the route vector.

The vector database is updated with real-time traffic information for each road section and is configured to allow the vector search unit to refer to it.

Existing large language model technologies are limited in providing real-time traffic information, as they generate responses from within learned data.

By contrast, the present disclosure uses a large language model (LLM) incorporating retrieval-augmented generation (RAG) when generating traffic information-providing sentences, thus enabling real-time explanation of causes of traffic congestion.

Here, because it performs searching based on real-time external data, the retrieval-augmented generation large language model may mitigate large language model hallucinations and provide more accurate real-time information.

For example, the vector generation unit 130a and the vector search unit 130b may perform similarity searches using a vector search module, such as Facebook FAISS, Milvus, or Annoy, executed on a server equipped with a processor and storage. For example, the vector generation unit 130a and the vector search unit 130b may use the vector search module to convert an input query (e.g., a route including a congestion section) into a vector and perform a nearest-neighbor search in the vector database.

The text generation unit 130c generates a sentence comprising at least one of the location of the traffic congestion section, the cause of the traffic congestion, or the expected delay time based on the retrieved traffic information vector and a preset sentence template.

Here, the text generation unit may generate a sentence using a retrieval-augmented generation large language model.

Accordingly, the apparatus for providing real-time traffic information may, based on the travel route set in the user vehicle, select a congestion section from among road sections included in the travel route, perform a similarity search in the vector database to select traffic information related to the route vector including the selected congested section, and generate a sentence by combining retrieved keywords. The apparatus for providing real-time traffic information may provide the sentence to the user vehicle.

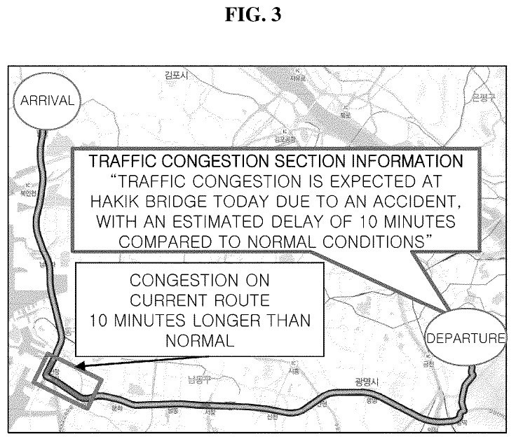

FIG. 3 is a diagram illustrating an example of a method for providing real-time traffic information according to one embodiment of the present disclosure.

For example, referring to FIG. 3, the selected congestion section is Hakik Bridge, the retrieved cause of the congestion is a traffic accident, and the expected delay time is 10 minutes, and the preset sentence template is: “Traffic congestion is expected at (selected congestion section) due to (cause of traffic congestion), with an estimated delay of (expected delay time) compared to normal conditions.”

As described above, when the traffic congestion section information providing unit 130 is designed to retrieve only traffic congestion sections along the travel route, information on road sections classified as real-time traffic congestion sections may be provided.

By contrast, when the traffic congestion section information providing unit 130 is designed to retrieve all road section information included in the travel route, if, from among sections not currently classified as a traffic congestion section, a cause of traffic congestion (e.g., a scheduled rally, event, traffic control, or roadworks) is retrieved for a user's estimated arrival time, traffic congestion section information thereon can be provided. The user's estimated arrival time may be calculated based on a required travel time for each road section, and the required travel time for each road section may be calculated based on the normal speed range for each section and an expected delay time at a prior stopover, etc.

In addition, the traffic congestion section information providing unit 130 may be designed to provide traffic congestion section information limited to travel routes frequently traveled by a user, thereby restricting the provision of unnecessary information. For example, when the user vehicle deviates from its travel pattern (e.g., route, time, day of the week), output of traffic congestion section information by the traffic congestion section information providing unit may be limited.

According to the apparatus for providing real-time traffic information according to the present disclosure, by providing the user with advance notice of traffic congestion sections, a detour route that allows the user vehicle to avoid traffic congestion sections can be provided to the user. In addition, the user may also be provided with an expected delay time compared to normal conditions, thus providing the user with information relating to a departure time.

The apparatus for providing real-time traffic information according to the present disclosure vectorizes the user's travel route and real-time traffic information, performs a similarity search in the vector database, and then selects real-time traffic information related to the travel route of the user. The selected real-time traffic information is appropriately arranged and processed within a preset template and inputted into a large language model prompt, and a traffic information provision sentence according to the input is outputted.

Accordingly, users are provided not only with the location of traffic congestion sections but also with explanations of the cause of the traffic congestion, thereby enhancing their understanding of detour route guidance according to the congestion sections, thus improving driving satisfaction and preventing entry into congestion sections.

As used in the present disclosure (especially in the appended claims), the terms “a/an” and “the” include both singular and plural referents, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps of the method according to the present disclosure may be performed in an appropriate order unless a specific order is described or otherwise specified. In other words, the present disclosure is not necessarily limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example embodiments described above or by the use of such terms unless limited by the appended claims. Also, it should be apparent to those having ordinary skill in the art that various modifications, combinations, and alternations may be made depending on design conditions and factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. An apparatus for providing real-time traffic information, the apparatus comprising:
a traffic information collection unit configured to collect, in real time while a user vehicle is travelling along a travel route, traffic information comprising a real-time travel speed and a cause of traffic congestion;
a traffic congestion section determination unit configured to determine a normal speed range based on the traffic information and determine a section with a real-time travel speed lower than a lower limit of the normal speed range as a traffic congestion section; and
a traffic congestion section information providing unit configured to provide traffic congestion section information comprising at least one of a location of the traffic congestion section, the cause of the traffic congestion, or an expected delay time based on the traffic information and the traffic congestion section included in the travel route of the user vehicle.

2. The apparatus according to claim 1,
wherein the traffic information collection unit is further configured to collect the cause of the traffic congestion based on a real-time traffic image provided through an intelligent transport system and an image analysis model, and
wherein the traffic information comprises at least one of real-time traffic accident information, rally information, event information, traffic control information, or roadwork information.

3. The apparatus according to claim 2, wherein the traffic congestion section determination unit is further configured to determine the normal speed range according to a preset cycle by using a traffic pattern prediction model that uses the real-time travel speed as training data.

4. The apparatus according to claim 3, wherein the traffic congestion section information providing unit comprises a vector generation unit configured to:
generate a traffic information vector by dividing and expanding the traffic information based on at least one of a preset token count unit, a sentence boundary, or a paragraph boundary and performing vectorization; and
generate a route vector by dividing and expanding the traffic congestion section included in the travel route of the user vehicle based on at least one of a preset token count unit, a sentence boundary, or a paragraph boundary and performing vectorization.

5. The apparatus according to claim 4, wherein the traffic congestion section information providing unit further comprises a vector search unit configured to retrieve a traffic information vector that is close to the route vector.

6. The apparatus according to claim 5,
wherein the traffic congestion section information providing unit further comprises a text generation unit configured to generate a sentence comprising at least one of the location of the traffic congestion section, the cause of the traffic congestion, or the expected delay time based on the retrieved traffic information vector and a preset sentence template, and
wherein the traffic congestion section information providing unit is further configured to provide the traffic congestion section information based on the generated sentence.

7. The apparatus according to claim 6, wherein the expected delay time is determined based on the normal speed range and the real-time travel speed.

8. The apparatus according to claim 7, wherein the text generation unit is further configured to generate the sentence by using a retrieval-augmented generation large language model.

9. A method for providing real-time traffic information, the method comprising:
collecting, in real time while a user vehicle is travelling along a travel route, traffic information comprising a real-time travel speed and a cause of traffic congestion;
calculating a normal speed range based on the traffic information;
determining a section with a real-time travel speed lower than a lower limit of the normal speed range as a traffic congestion section; and
providing traffic congestion section information comprising at least one of a location of the traffic congestion section, the cause of the traffic congestion, or an expected delay time based on the traffic information and the traffic congestion section included in the travel route of the user vehicle.

10. The method according to claim 9,
wherein collecting the traffic information in real time comprises collecting the cause of the traffic congestion based on a real-time traffic image provided through an intelligent transport system and an image analysis model, and
wherein the traffic information comprises at least one of real-time traffic accident information, rally information, event information, traffic control information, or roadwork information.

11. The method according to claim 10, wherein determining a section as a traffic congestion section comprises calculating the normal speed range according to a preset cycle by using a traffic pattern prediction model that uses the real-time travel speed as training data.

12. The method according to claim 11, wherein providing traffic congestion section information comprises:
generating a traffic information vector by dividing and expanding the traffic information based on at least one of a preset token count unit, a sentence boundary, or a paragraph boundary and performing vectorization; and
generating a route vector by dividing and expanding the traffic congestion section included in the travel route of the user vehicle based on at least one of a preset token count unit, a sentence boundary, or a paragraph boundary and performing vectorization.

13. The method according to claim 12, wherein providing traffic congestion section information further comprises retrieving a traffic information vector that is close to the route vector.

14. The method according to claim 13,
wherein providing traffic congestion section information further comprises generating a sentence comprising at least one of the location of the traffic congestion section, the cause of the traffic congestion, or the expected delay time based on the retrieved traffic information vector and a preset sentence template, and
wherein providing traffic congestion section information further comprises providing the traffic congestion section information based on the generated sentence.

15. The method according to claim 14, further comprising determining the expected delay time based on the normal speed range and the real-time travel speed.

16. The method according to claim 15, wherein generating the sentence comprises generating the sentence by using a retrieval-augmented generation large language model.
